(19) United States
(12) Patent Application Publication
(10) Pub. No.: US 2018/0367806 A1
(43) Pub. Date: Dec. 20, 2018

(54) VIDEO ENCODING APPARATUS AND VIDEO DECODING APPARATUS

(71) Applicant: RENESAS ELECTRONICS CORPORATION, Tokyo (JP)

(72) Inventors: Seiji MOCHIZUKI, Tokyo (JP); Katsushige MATSUBARA, Tokyo (JP)

(21) Appl. No.: 15/950,609

(22) Filed: Apr. 11, 2018

(30) Foreign Application Priority Data
Jun. 16, 2017 (JP) 2017-118487

(51) Int. Cl. H04N 19/186; H04N 19/50; H04N 19/182; H04N 19/103; H04N 19/184

(52) U.S. Cl. CPC H04N 19/186; H04N 19/50; H04N 19/184; H04N 19/103; H04N 19/182

(57) ABSTRACT

A video encoding circuit includes a prediction image generation unit configured to receive a plurality of pictures, each of the pictures containing a plurality of components, search for a reference image from components of a picture itself or an already-encoded picture stored in a reference memory, and generate a prediction image based on information on a pixel contained in the reference image, the plurality of components corresponding to respective color components contained in the input picture and having wavelengths different from each other, the reference image being used for encoding of each of the plurality of components contained in the input picture, and an encoding unit configured to generate a bit stream based on the prediction image output from the prediction image generation unit, in which the prediction image generation unit outputs a reference component index indicating information on a component containing the reference image.

### CROSS-REFERENCE TO RELATED APPLICATIONS

This application is based upon and claims the benefit of priority from Japanese patent application No. 2017-118487, filed on Jun. 16, 2017, the disclosure of which is incorporated herein in its entirety by reference.

### BACKGROUND

The present disclosure relates to a video encoding apparatus and a video decoding apparatus.

Images of digital cameras, video cameras, and the like are displayed by reproducing colors close to the colors viewed by human eyes by using the three primary colors of red (R), green (G), and blue (B). Further, recently, a technique in which an image analysis is performed on, in addition to information on the three primary colors of RGB, information on light invisible to human eyes such as infrared light and ultraviolet light or information obtained by photographing a subject by using specific wavelengths in RGB, and the analyzed information is used for sugar content analyses of fruits, pathological analyses of internal organs, or the like has been developed.

A multispectral image (also referred to as a “multiband image” or a “multichannel image”) including a large number of color components other than RGB, such as the above-described image, contains a large number of spectrums. Therefore, an amount of data on such an image tends to increase. Therefore, it is required to compress image data and thereby reduce the amount of the data when such a multispectral image is used in communication or the like, or recorded in a recording medium. As a method for compressing a multispectral image, for example, an invention disclosed in Japanese Unexamined Patent Application Publication No. 2008-301428 has been known.

### SUMMARY

However, the present inventors have found the following problem. That is, in the invention disclosed in Japanese Unexamined Patent Application Publication No. 2008-301428, a multispectral image is compressed after converting it into a three-band image. However, when it is attempted to compress the information by the above-described method or when it is attempted to compress the information by encoding the converted three-band image, the information may not be compressed in some cases in which all the information over the multi-spectrums is used.

Accordingly, it has been desired to develop a video encoding apparatus and a video decoding apparatus capable of efficiently encoding, compressing, expanding (i.e., decompressing), and using a multispectral image. Other problems and novel features will be apparent from the description of this specification and the accompanying drawings.

According to one embodiment, for a picture containing a plurality of spectrums (hereinafter referred to as “components”), predictive encoding is performed by referring to information on a component contained in the picture itself to be encoded or an already-encoded picture, and index information specifying a component containing a reference image is incorporated into a data stream. Note that in the following description, “components” are element corresponding to color components contained in a picture and mean those having different wavelengths.

According to the above-described embodiment, it is possible to provide a video encoding apparatus and a video decoding apparatus capable of efficiently encoding, compressing, expanding (i.e., decompressing), and using a picture containing a large number of components.

Note that entities that express the apparatus according to the above-described embodiment as a method or a system, programs that cause a computer to execute the apparatus or a part of the apparatus, LSIs, in-vehicle cameras, in-vehicle periphery monitoring systems, in-vehicle driving assistance systems, in-vehicle automatic driving systems, AR systems, industrial use video processing systems, and image processing systems including the apparatus are also regarded as embodiments according to the present disclosure.

### BRIEF DESCRIPTION OF THE DRAWINGS

The above and other aspects, advantages and features will be more apparent from the following description of certain embodiments taken in conjunction with the accompanying drawings, in which:

FIG. 1 is a graph showing a distribution of wavelengths of color components contained in a picture;

FIG. 2 is a block diagram showing a schematic configuration of a video encoding circuit 1 according to a first embodiment;

FIG. 3 is a diagram for explaining a configuration of a picture according to the first embodiment;

FIG. 4 is a block diagram showing a schematic configuration of a prediction image generation unit 10 according to the first embodiment;

FIG. 5 is a diagram for explaining a reference relation among a plurality of pictures according to the first embodiment;

FIG. 6 is a diagram for explaining a hierarchical structure of bit streams according to the first embodiment;

FIG. 7 is a diagram for explaining a detailed structure of bit streams according to the first embodiment;

FIG. 8 is a block diagram showing a schematic configuration of a video image decoding circuit 5 according to the first embodiment;

FIG. 9 is a block diagram showing a schematic configuration of a semiconductor device 100 according to the first embodiment;

FIG. 10 is a diagram for explaining a schematic structure of a bit stream according to a third embodiment;

FIG. 11 is a diagram for explaining a schematic structure of a bit stream according to the third embodiment;

FIG. 12 is a block diagram showing a schematic configuration of a prediction image generation unit 20 according to a fourth embodiment; and

FIG. 13 is a block diagram showing a schematic configuration of a video image decoding circuit 6 according to the fourth embodiment.

### DETAILED DESCRIPTION

For clarifying the explanation, the following descriptions and the drawings may be partially omitted and simplified as appropriate. Further, each of the elements that are shown in the drawings as functional blocks for performing various processes can be implemented by hardware such as a CPU, a memory, and other types of circuits, or implemented by software such as a program loaded in a memory.

Therefore, those skilled in the art will understand that these functional blocks can be implemented solely by hardware, solely by software, or a combination thereof. That is, they are limited to neither hardware nor software. Note that the same symbols are assigned to the same components throughout the drawings and duplicated explanations are omitted as required.

The program can be stored and provided to a computer using any type of non-transitory computer readable media.

Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.).

The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Firstly, for the purpose of clarifying a configuration according to an embodiment, studies and discussions that the inventors of the present application have made are explained hereinafter before explaining the embodiment.

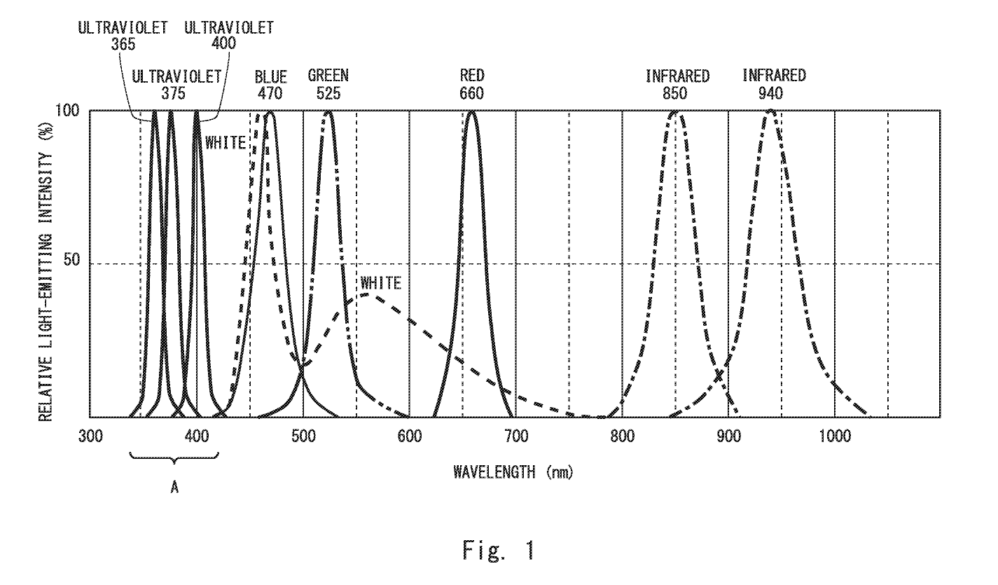

FIG. 1 is a diagram showing a distribution of wavelengths of color components contained in a picture.

FIG. 1 shows, in addition to the three primary color components of red (R), green (G) and blue (B), distributions of wavelengths of components other than these three primary colors, such as ultraviolet right and infrared light. When a picture containing three primary colors is encoded, in general, data of the three primary colors of RGB are first converted into two components, i.e., into a luminance and a color difference. Then, encoding is performed on each of these two components, i.e., on the luminance and the color difference.

However, in the case of a picture containing components other than the three primary colors, unlike the case of a picture containing only the three primary color components, there is a range in which wavelengths of components are close to each other (e.g., a range A in FIG. 1). It is presumed that components having wavelength distributions close to each other have properties similar to each other. Based on this presumption, the inventors of the present application have found that a picture containing a plurality of components can be encoded more efficiently by using information on adjacent components.

Embodiments will be described hereinafter in detail.

### First Embodiment

A video encoding circuit and a video decoding circuit according to a first embodiment compress and expand (i.e., decompress) information by using a correlation among three components or more in a non-orthogonalized color space (e.g., a picture containing a large number of components). Specifically, by incorporating information on the number of components and a reference component index indicating a component containing a reference image into a bit stream, which is compressed data, it is possible to perform an image prediction based on components other than the components to be encoded (hereinafter also referred to as “encoding target components”). As a result, it is possible to efficiently perform an encoding process or a decoding process.

Note that the video encoding circuit and the video decoding circuit constitute all or a part of a video encoding apparatus and a video decoding apparatus, respectively.

Further, in the following description, compressed data in a state in which it is output to a transmission line in the form of a bit string is referred to as a “bit stream”.

Firstly, a configuration and an operation of a video encoding circuit according to the first embodiment are explained.

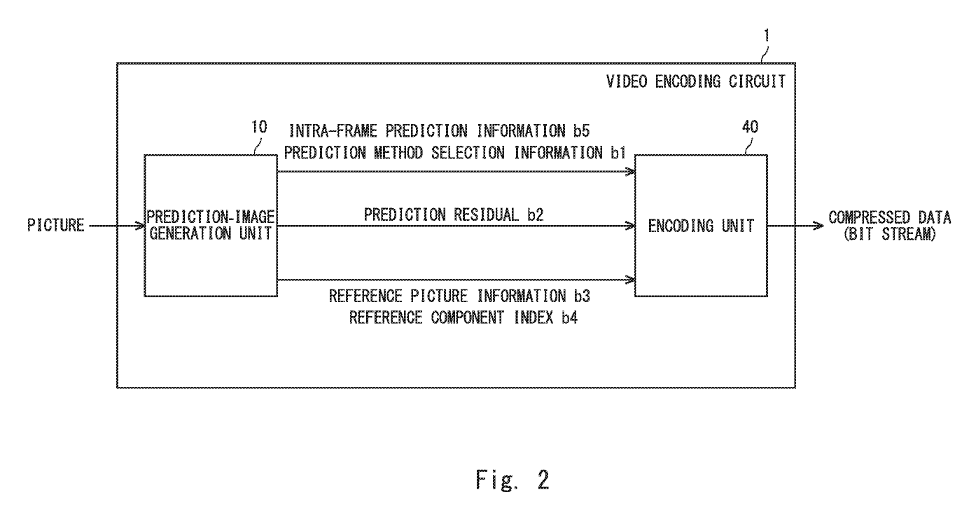

FIG. 2 is a block diagram showing a schematic configuration of a video encoding circuit 1 according to the first embodiment.

The video encoding circuit 1 includes a prediction image generation unit 10, an encoding unit 40, and so on. The prediction image generation unit 10 externally receives a picture and outputs prediction method selection information b1 indicating which prediction method is used to predict the picture, a prediction residual b2, a reference picture information b3 indicating picture information containing a reference image for making a prediction, a reference component index b4 indicating a component containing the reference image, and intra-frame prediction information b5.

There are two types of prediction methods, i.e., an inter-frame prediction and an intra-frame prediction. Further, a selected prediction method is output as prediction method selection information b1. In the first embodiment, the inter-frame prediction includes a prediction based on different components in the same picture (i.e., in one picture). The input pictures are a plurality of temporally-sequential pictures and each of these pictures contains a plurality of components.

The encoding unit 40 performs variable-length encoding on information output from the prediction image generation unit 10 and thereby generates a bit stream. In this process, the encoding unit 40 encodes the prediction method selection information b1, the prediction residual b2, the reference picture information b3, the reference component index b4, and the intra-frame prediction information b5 output from the prediction image generation unit 10, and generates a bit stream containing these information items.

When the prediction method is the intra-frame prediction, the encoding unit 40 incorporates the intra-frame prediction information b5, the prediction method selection information b1, and the prediction residual b2 into the bit stream. On the other hand, when the prediction method is the inter-frame prediction, the encoding unit 40 incorporates the reference picture information b3, the reference component index b4, and the prediction residual b2 into the bit stream. When the prediction method is the intra-frame prediction, the video encoding circuit 1 makes a prediction based on the same component of the same picture. On the other hand, when the prediction method is the inter-frame prediction, the video encoding circuit 1 makes a prediction based on the same component or other components contained in the same picture or other pictures.

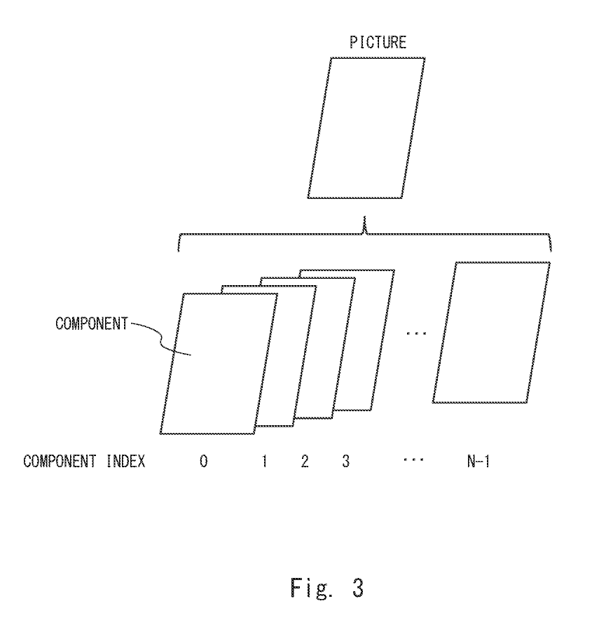

FIG. 3 is a diagram for explaining a structure of a picture according to the first embodiment.

Each picture contains a plurality of components and a component index is assigned to each of the components. For example, when a picture is composed of N components, component indexes 0 to N-1 are assigned to these components, respectively. Further, the plurality of components may include at least one component in a wavelength region whose wavelength is longer than that of red and a component in a wavelength region whose wavelength is shorter than that of blue.

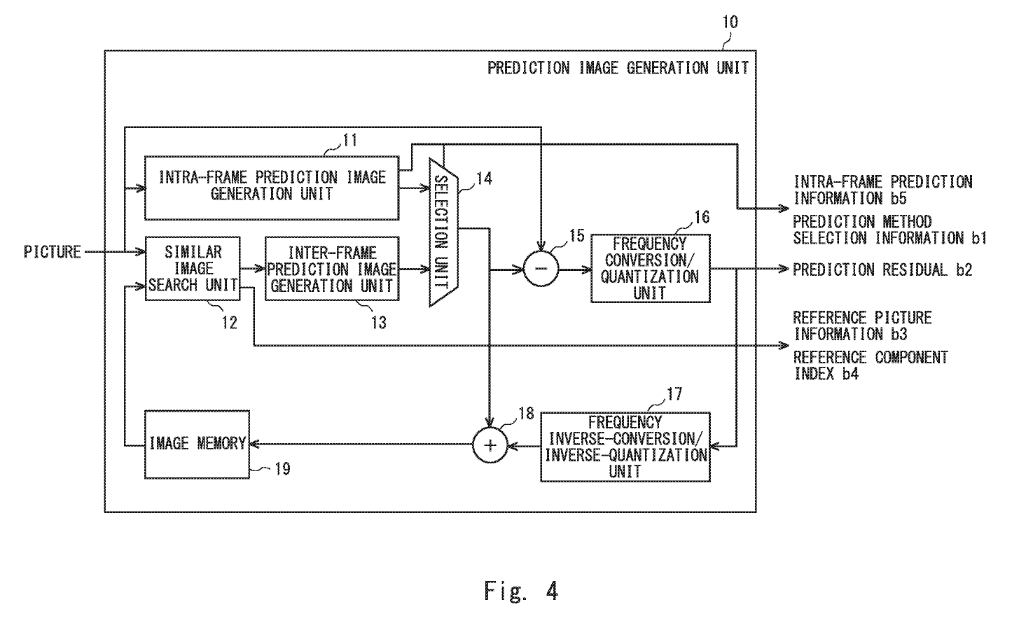

FIG. 4 is a block diagram showing a schematic configuration of the prediction image generation unit 10 according to the first embodiment.

The prediction image generation unit 10 includes an intra-frame prediction image generation unit 11, a similar image search unit 12, an inter-frame prediction image generation unit 13, a selection unit 14, a subtraction unit 15, a frequency conversion/quantization unit 16, a frequency inverse-conversion/inverse-quantization unit 17, an addition unit 18, an image memory 19, and so on.

The intra-frame prediction image generation unit 11 receives a picture and generates a prediction image for each of the components constituting the picture. Each picture contains macro-blocks obtained by subdividing that picture or sub-blocks obtained by further subdividing the macro-blocks as units for images to be encoded (hereinafter also referred to as “encoding target images”). The intra-frame prediction image generation unit 11 generates a prediction image for each macro-block or each sub-block by using an intra-frame prediction and outputs the generated prediction image to the selection unit 14. Examples of the method for generating an intra-frame prediction image include a method for making a prediction by using an average value of surrounding pixels of the encoding target image, a method for copying already-encoded pixels adjacent to the encoding target image in a specific direction, and so on. However, the method is not limited to these examples.

The intra-frame prediction image generation unit 11 also outputs information necessary for the intra-frame prediction (e.g., specific direction information indicating a direction in which already-encoded pixels are copied and the like) as the intra-frame prediction information b5 to the encoding unit 40.

The similar image search unit 12 receives a picture and searches for a similar image for each of the components constituting the picture and for each of the encoding target images included in each component. Specifically, the similar image search unit 12 searches for a similar image by searching for a similar image that has the highest degree of similarity and can be used for a prediction of encoding for the encoding target image from reference pictures (local decoded pictures) stored in the image memory 19 by performing block matching or the like. After searching for the similar image, the similar image search unit 12 outputs information including position information of the similar image (e.g., a vector indicating a relative position between the similar image and the encoding target image or the like) to the inter-frame prediction image generation unit 13.

An image area (a pixel group) having the highest degree of similarity used for the prediction of encoding is often a different component in the same position in the same picture as those of the encoding target image. Further, the component having the highest degree of similarity varies depending on the picture or the position in the picture.

Therefore, the similar image search unit 12 searches for a similar image for each component of the same picture including the encoding target image and for each component of a picture different from the picture including the encoding target image. For the calculation of similarity, a commonly used technique such as a sum of absolute value differences (SAD) may be used. Further, a necessary code quantity may be taken into account by using a technique such as rate distortion (RD) optimization. Further, the similar image search unit 12 outputs reference picture information b3 indicating the picture containing the similar image and a reference component index b4 indicating a component containing the similar image to the encoding unit 40. Note that the similar image, which is selected as a result of the search, is used as a reference image for generating a prediction image later.

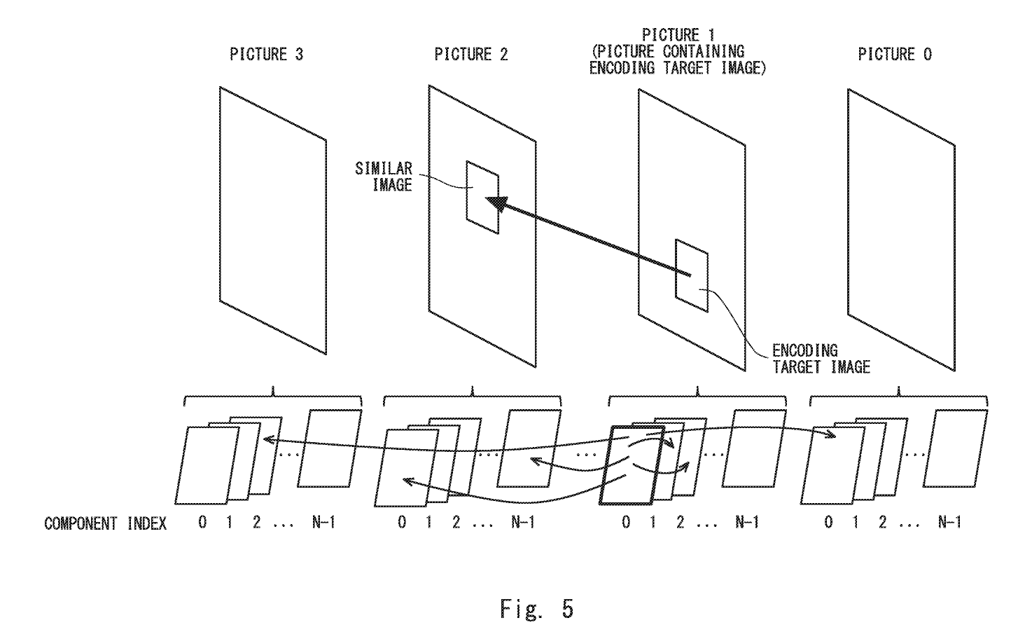

FIG. 5 is a diagram for explaining a reference relation among a plurality of pictures according to the first embodiment.

For a picture (a picture 1) to which the encoding target image belongs, the similar image search unit 12 searches, for each component, an area that is already encoded and stored in the image memory 19. Further, for pictures (pictures 0, 2 and 3) to which the encoding target image does not belong, the similar image search unit 12 searches each component contained in a reference picture that is already encoded and stored in the image memory 19.

Then, for the similar image obtained as a result of the search, the similar image search unit 12 outputs reference picture information b3 indicating a picture number of the picture containing the similar image (e.g., 0, 1, 2 or 3) and a reference component index indicating information on the component containing the similar image (e.g., one of numbers 0 to N-1) to the encoding unit 40.

Referring to FIG. 4 again, the inter-frame prediction image generation unit 13 generates a prediction image for each encoding target image based on information on the similar image (a vector indicating a position, a pixel value, etc.) found by the similar image search unit 12. The found similar image is also referred to as a “reference image” and is used for generating a prediction image. Then, the inter-frame prediction image generation unit 13 outputs the generated prediction image to the selection unit 14.

The selecting unit 14 compares the similarity between the prediction image output from the intra-frame prediction image generation unit 11 and the encoding target image with the similarity between the prediction image output from the inter-frame prediction image generation unit 13 and the encoding target image, and thereby selects a prediction method by which a prediction image having higher similarity is generated. Then, the selection unit 14 outputs the prediction image predicted by the selected prediction method to the subtraction unit 15 and the addition unit 18. Further, the selection unit 14 outputs prediction method selection information b1 to the coding unit 40.

The subtraction unit 15 calculates a difference between the input picture and the prediction image and thereby generates a prediction residual b2. Then, the subtraction unit 15 outputs the generated prediction residual b2 to the frequency conversion/quantization unit 16.

The frequency conversion/quantization unit 16 performs a frequency conversion and quantization on the prediction residual b2 and outputs the quantized prediction residual b2 and a conversion coefficient used for the quantization to the encoding unit 40 and the frequency inverse-conversion/inverse-quantization unit 17.

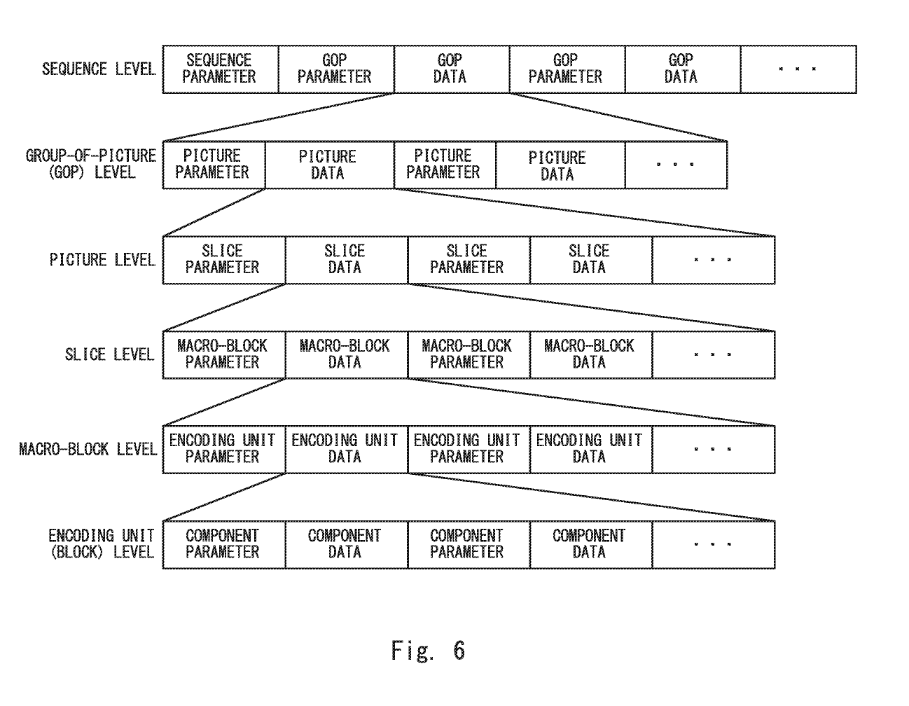

FIG. 6 is a diagram for explaining a hierarchical structure of a bit stream according to the first embodiment. The bit stream has a hierarchy including, for example, a sequence level, a group-of-picture (GOP) level, a picture level, a slice level, a macro-block level, a block level, etc. It should be noted that this hierarchy is merely an example and the hierarchy is not limited to this structure.

The sequence level contains a plurality of GOP parameters and GOP data, and the GOP level contains a plurality of picture parameters and picture data. The same applies to the slice level, the picture level, the macro-block level, and the block level, and their explanations are omitted here.

Each level includes parameters and data. The parameters are located in front of the data in the bit stream and include, for example, setting information for an encoding process. For example, in the case of the sequence parameter, it includes information items such as the number of pixels contained in the picture, an aspect ratio indicating a ratio between a vertical size of the picture and a horizontal size thereof, and a frame rate indicating the number of pictures played back per second.

The GOP parameters include time information for synchronizing videos with sounds. Further, the picture parameters include information items such as a type of the picture (I-picture, P-picture, or B-picture), information on a motion compensation prediction, a displaying order in the GOP, etc. The macro-block parameters include information indicating a prediction method (an inter-frame prediction or an intra-frame prediction). Further, when the prediction method is the inter-frame prediction, the macro-block parameters include information such as reference picture information b3 indicating a picture to be referred to.

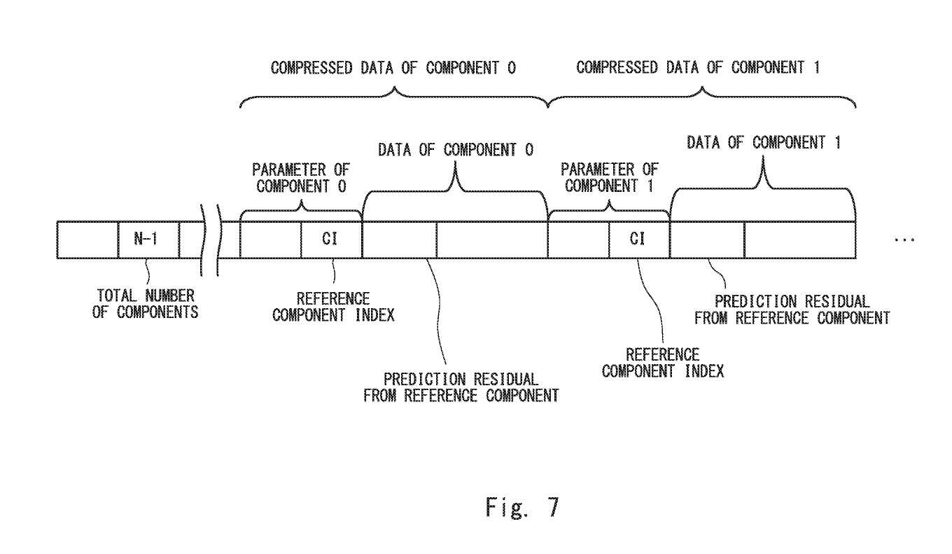

FIG. 7 is an explanatory diagram of a structure of a bit stream according to the first embodiment, and is a detailed diagram of a structure of the encoding unit (block) level shown in FIG. 6.

The component parameters include a reference component index indicating a component containing a reference image. Further, the component data includes a prediction residual which is a difference value between the reference image indicated by the reference component index and the prediction image. Information on the total number N of components (e.g., N is four or larger) is included in parameters in the picture layer or a higher layer. More specifically, it is included in one of the slice parameter group, the picture parameter group, and the GOP parameter group.

The encoding unit 40 encodes the prediction method selection information b1, the prediction residual b2, the reference picture information b3, the reference component index b4, and the intra-frame prediction information b5, and outputs a bit stream containing these encoded information items. Further, the encoding unit 40 incorporates information on the predetermined number of components in one of the parameter groups in the picture layer and higher layers in the bit stream. By incorporating the information on the number of components in the parameter group in the picture layer or a higher layer, when the video decoding circuit receives the bit stream, it can acquire the information on the number N of components, determine a size of a memory area necessary for the decoding, and secure the necessary memory area.

Since the video decoding circuit can secure a memory area having a necessary size, it can perform the decoding while efficiently using the memory area. Further, by acquiring the information on the number of components, the video decoding circuit can determine the end of the unit for encoding when it completes the decoding of N components. Note that the above-described information items b1 to b5 are representative examples of information items contained in the bit stream. That is, needless to say, information items other than the above-described information items (e.g., a conversion coefficient used for quantization and other setting values necessary for encoding) are also contained in the bit stream.

The frequency inverse-conversion/inverse-quantization unit 17 performs a frequency inverse-conversion/inverse-quantization process on the prediction residual by using the conversion coefficient used for the quantization, and outputs its processing result to the addition unit 18.

The addition unit 18 adds the processing result and the prediction image, and thereby generates a reference image (a local decoded picture). Then, the addition unit 18 outputs the generated reference image to the image memory 19. Note that operations performed by the frequency inverse-conversion/inverse-quantization unit 17 and the addition unit 18 may be similar to those performed in the related art.

The image memory 19 stores the reference image and the reference image is used for encoding of other pictures.

As described above, there is a correlation among non-orthogonalized components in an image including a large number of components. Therefore, the video encoding circuit 1 according to the first embodiment is able to efficiently encode/compress a picture containing a large number of components by incorporating information on the number of components and a reference component index indicating a component containing a reference image into compressed data and performing an image prediction based on not only encoding target components but also components other than the encoding target components.

Next, a configuration and an operation of the video decoding circuit according to the first embodiment are explained.

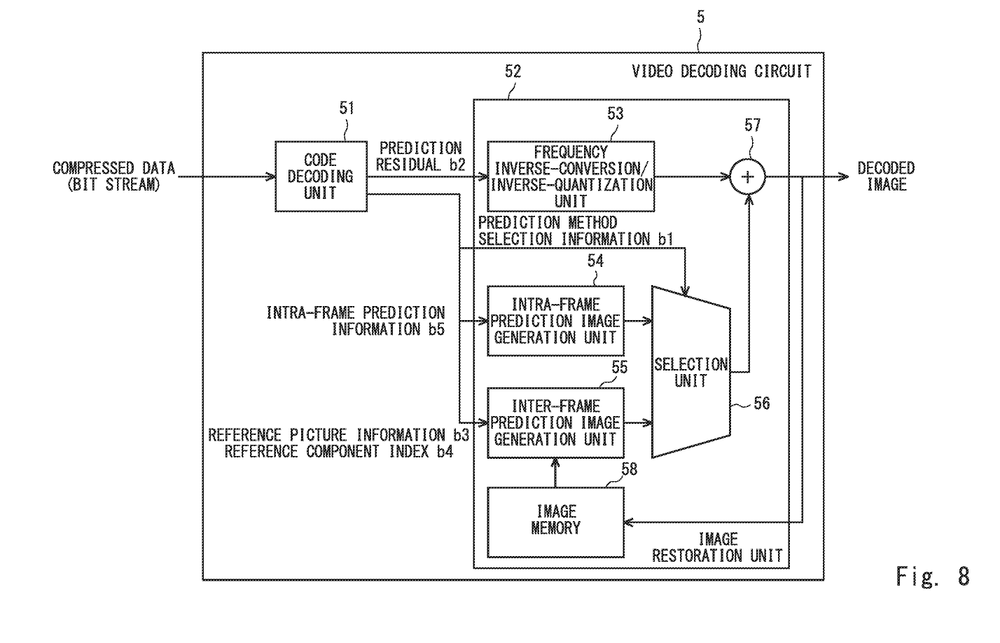

FIG. 8 is a block diagram showing a schematic configuration of a video decoding circuit 5 according to the first embodiment.

The video decoding circuit 5 includes a code decoding unit 51, an image restoration unit 52, and so on. Further, the image restoration unit 52 includes a frequency inverse-conversion/inverse-quantization unit 53, an intra-frame prediction image generation unit 54, an inter-frame prediction image generation unit 55, a selection unit 56, an addition unit 57, an image memory 58, and so on.

The code decoding unit 51 receives a bit stream and decodes its code. Further, regarding data contained in the bit stream, the code decoding unit 51 outputs a conversion coefficient that was used in quantization and a prediction residual b2 to the frequency inverse-conversion/inverse-quantization unit 53, outputs intra-frame prediction information b5 to the intra-frame prediction image generation unit 54, outputs reference picture information b3 and a reference component index b4 to the inter-frame prediction image generation unit 55, and outputs prediction method selection information b1 to the selection unit 56.

The frequency inverse-conversion/inverse-quantization unit 53 performs a frequency inverse-conversion/inverse-quantization process on the prediction residual b2 by using the conversion coefficient used in the quantization, and outputs its processing result to the addition unit 57. The intra-frame prediction image generation unit 54 generates a prediction image based on the intra-frame prediction information b5.

The inter-frame prediction image generation unit 55 generates a prediction image based on the reference picture information b3, the reference component index b4, and a reference image stored in the image memory 58.

In this process, the reference image referred to by the inter-frame prediction image generation unit 55 includes a reference image obtained from each component of a picture to which the image to be decoded (hereinafter also referred to as “decoding target image”) belongs and a reference image obtained from each component of a picture to which the decoding target image does not belong.

The selection unit 56 performs a selection based on the prediction method selection information b1 so that a prediction image that is predicted by a prediction method indicated by the prediction method selection information b1 is output to the addition unit 57.

The addition unit 57 adds the processing result of the frequency inverse-conversion/inverse-quantization and the prediction image, and thereby generates a decoded image.

As described above, the video decoding circuit 5 according to the first embodiment is able to efficiently expand (i.e., decompress) an image containing a plurality of components by using information on the number of components and a reference component index indicating a component containing a reference image, both of which are contained in the bit stream, and thereby performing an image prediction based on not only encoding target components but also components other than the encoding target components.

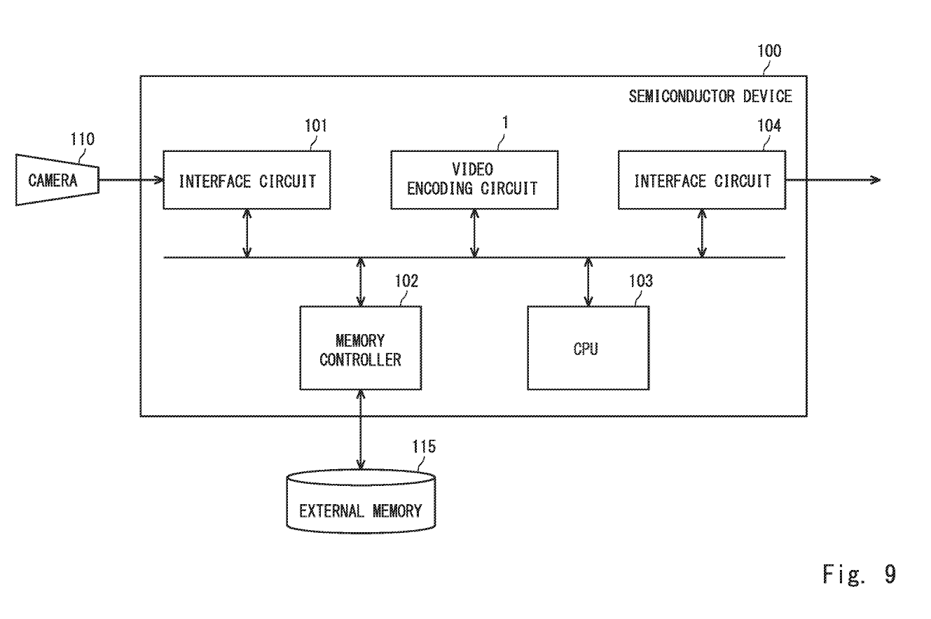

FIG. 9 is a block diagram showing a schematic configuration of a semiconductor device 100 according to the first embodiment.

The semiconductor device 100 includes an interface circuit 101 that receives a picture from an external camera 110, a memory controller 102 that reads and writes data from and to an external memory 115, a CPU 103, the above-described video encoding circuit 1, an interface circuit 104 that externally outputs a bit stream, and so on.

The interface circuit 101 receives a picture containing a plurality of components from the camera 110. The input picture is stored in the external memory 115 by the memory controller 102.

In addition to storing a picture supplied from the camera in the external memory 115, the memory controller 102 transfers image data and image management data necessary for processing performed in the video encoding circuit 1 between the external memory 115 and the video encoding circuit 1 according to an instruction from the CPU 103. The CPU 103 controls the video encoding circuit 1 and controls the transfer performed by the memory controller 102, and so on. The interface circuit 104 outputs a bit stream generated by the video encoding circuit 1 to an external transmission line.

Although the semiconductor device 100 shown in FIG. 9 is entirely composed of circuits, the video encoding circuit 1 may be composed of software. In that case, the video encoding circuit 1 is stored as a program in the external memory 115 and is controlled by the CPU 103.

As described above, the video encoding circuit 1 according to the first embodiment includes a prediction image generation unit 10 configured to receive a plurality of pictures, each of the pictures containing a plurality of components, search for a reference image from components of a picture itself or an already-encoded picture stored in a reference memory, and generate a prediction image based on information on a pixel contained in the reference image, the plurality of components corresponding to respective color components contained in the input picture and having wavelengths different from each other, the reference image being used for encoding of each of the plurality of components contained in the input picture; and an encoding unit 40 configured to generate a bit stream based on the prediction image output from the prediction image generation unit 10, in which the prediction image generation unit 10 outputs a reference component index indicating information on a component containing the reference image, and the encoding unit 40 outputs a bit stream containing information on the reference component index.

Further, in the video encoding circuit 1 according to the first embodiment, information indicating the number of components contained in the picture is preferably incorporated into the bit stream.

Further, in the video encoding circuit 1 according to the first embodiment, the number N of components contained in the picture is preferably four or larger.

Further, in the video encoding circuit 1 according to the first embodiment, the plurality of components preferably include at least one of a component in a wavelength region whose wavelength is longer than that of red and a component in a wavelength region whose wavelength is shorter than that of blue.

Further, the video decoding circuit 5 according to the first embodiment includes a code decoding unit 51 configured to receive a bit stream and decode the received bit stream, the bit stream containing a plurality of pictures encoded therein, each of the plurality of pictures containing a plurality of components, the plurality of components corresponding to respective color components contained in the picture and having wavelengths different from each other; and an image restoration unit 52 configured to generate a prediction image based on the decoded information and restore an image by using the prediction image, in which the code decoding unit 51 decodes code of a reference component index indicating information on a component containing a prediction image from the bit stream, and the image restoration unit 52 generates a prediction image by using a pixel value contained in the component indicated by the reference component index and restores an image by using the generated prediction image.

Further, in the video decoding circuit 5 according to the first embodiment, the decoded information preferably includes prediction method selection information indicating a method by which the predicted picture is generated and a prediction residual, the prediction residual being a difference between the prediction image and the picture.

### Second Embodiment

The video encoding circuit 1 and the video decoding circuit 5 according to the first embodiment set (i.e., use) a component number of a component containing a reference image as a reference component index. In contrast to this, a video encoding circuit and a video decoding circuit according to a second embodiment express a reference component index by using a component number of a component containing a reference image and a component number of a component containing an encoding target image.

In the second embodiment, in order to perform encoding, an encoding unit 40 assigns component numbers 0 to N-1 to respective components in ascending order (or descending order) of wavelengths of the components and expresses a reference component index CI by using a component number X of a component containing an encoding target image as expressed by an Expression (1) shown below:

CI=(Component number of component containing reference image)−X Expression (1).

When a component containing a similar image is searched for, a component having a wavelength close to that of a component containing an encoding target image is often selected as a result of the searching. Therefore, by using the Expression (1), it is possible to assign a smaller number to the reference component index CI and thereby efficiently perform encoding. Note that when the Expression (1) is used, the reference component index CI may become a negative number. In such a case, for example, an additional bit may be added to express the polarity (i.e., positive and negative). Alternatively, it is possible to renumber component numbers so that they are expressed by positive numbers, such as renumbering component numbers 0, 1, −1, 2, −2, . . . as 0, 1, 2, 3, 4 . . . .

For example, when the total number N of components is eight and component numbers of a component X containing an encoding target image and a component containing a reference image are 7 and 6, respectively, the reference component index is determined to be 1. When a component number of a component containing a reference image is used as it is as a reference component index, the reference component index becomes “6”. Therefore, at least three bits are required to express the number “6”.

In contrast to this, when the reference component index is expressed by using the Expression (1), the reference component index becomes “1”. Therefore, only one bit is required to express the number “1”. In this way, since the amount of information to be transmitted can be reduced, encoding can be efficiently performed.

The code decoding unit 51 acquires a reference component index CI and a component number X of a component containing an encoding target image from the bit stream. Then, for the component number X of the component containing the decoding target image, the reference component index is obtained by using the below-shown Expression (2).

(Component number of component containing reference image)=CI+X Expression (2)

The obtained reference component index CI is sent to the inter-frame prediction image generation unit 55 and a decoded image is generated there. In this way, it is possible to efficiently perform decoding with a smaller amount of transmitted information.

As described above, in the video encoding circuit 1 according to the second embodiment, the reference component index is preferably expressed by using a component number of a component containing an encoding target image and the number of components contained in the picture.

Further, in the video decoding circuit 5 according to the second embodiment, the reference component index is preferably expressed by using a component number of a component containing an encoding target image and the number of components contained in the picture.

### Third Embodiment

In the video encoding circuit 1 and the video decoding circuit 5 according to the first or second embodiment, an encoding process or a decoding process is efficiently performed by specifying a reference component index for each macro-block and incorporating the reference component index and information on the number of components into a bit stream. In contrast to this, in a video encoding circuit and a video decoding circuit according to a third embodiment, an encoding process or a decoding process is performed more efficiently by further incorporating flag information indicating a prediction method for each unit for encoding into a bit stream and thereby specifying an image prediction method for each component on a unit-for-encoding basis.

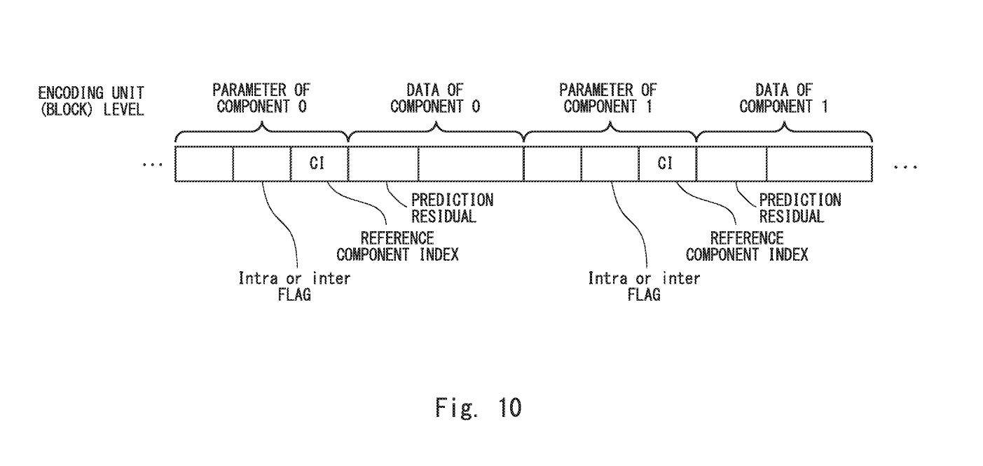

FIG. 10 is a diagram showing a structure of a bit stream output from ab encoding unit 40 according to the third embodiment.

Compared to the structure according to the first or second embodiment, the component parameters include an intra or inter flag indicating a prediction method. This intra or inter flag is a flag indicating whether a prediction method for encoding each component is an intra-frame prediction or an inter-frame prediction.

In the first or second embodiment, a prediction method is determined for each macro-block and the same prediction method is used for all of the plurality of components contained in the macro-block. In contrast to this, in the third embodiment, an intra or inter flag specifying a prediction method is included in the component parameters for each unit block for encoding, so that a prediction method can be changed for each component contained in each unit block for encoding. Note that configurations of the video encoding circuit and the video decoding circuit according to the third embodiment may be similar to those of the video encoding circuit 1 and the video decoding circuit 5 according to the first or second embodiment, and therefore they are not shown in the drawings and explanations of parts of them are omitted hereinafter.

Firstly, in a video encoding circuit 1 according to the third embodiment, a selection unit 14 selects a prediction method, i.e., selects an intra-frame prediction or an inter-frame prediction for each component of a block to be encoded (hereinafter also referred to as an “encoding target block”). Then, the selection unit 14 outputs the selected prediction method to the encoding unit 40 in the form of an intra or inter flag. As shown in FIG. 10, the encoding unit 40 generates a bit stream in which the intra or inter flag is included in its component parameters and outputs the generated bit stream to the moving picture decoding circuit 5. In the case of an image containing a large number of components, it is not uncommon that a specific component of a picture considerably differs from other components of that picture. Therefore, it is possible to perform an encoding process and a decoding process more efficiently by changing the prediction method only for the specific component.

Note that in the third embodiment as well as in other embodiments, for the encoding method performed by the encoding unit 40, fixed-length encoding may be used. Alternatively, variable-length encoding such as CBP (Constrained Baseline Profile) specified in MPEG-4 may be used.

Further, in the case of using the structure of a bit stream shown in FIG. 10, it is possible to convey a prediction method to the moving picture decoding circuit 5 by using an intra or inter flag and hence to eliminate the need for prediction method selection information b1 indicating a prediction method for each macro-block containing a plurality of components.

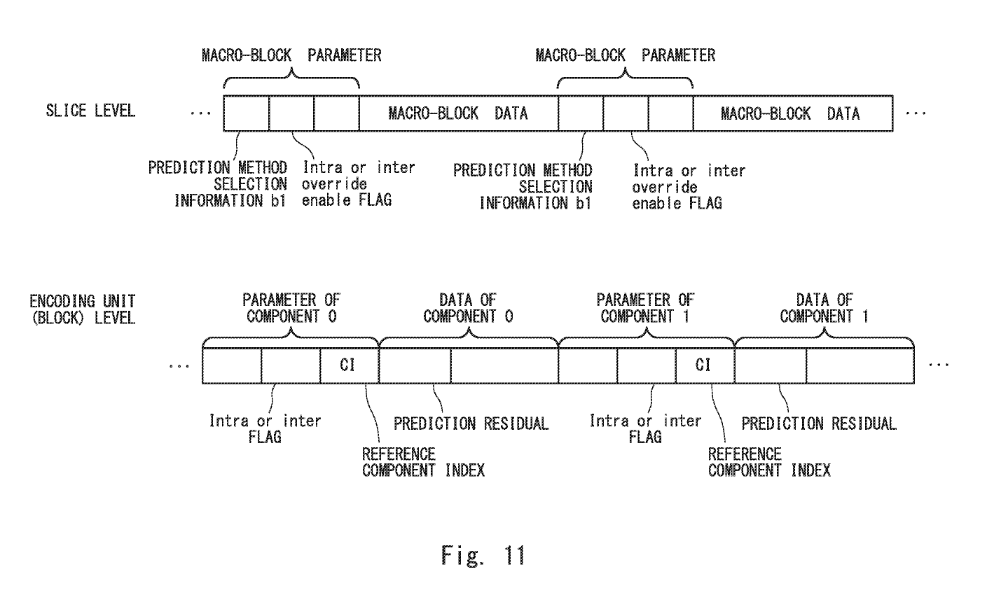

FIG. 11 is a diagram showing a schematic structure of a bit stream according to the third embodiment.

As shown in FIG. 11, the slice level may have both prediction method selection information b1 and an intra or inter flag. In FIG. 11, an intra or inter override enable flag is included in the macro-block parameters in addition to the prediction method selection information b1. When both the prediction method selection information b1 and the intra or inter flag are present in a bit stream, it is necessary to determine which of these information items should be referred to in order to determine a prediction method. To that end, when the intra or inter override enable flag is 1, a prediction method is determined by referring to a value of the inter or inter flag. Further, when the intra or inter override enable flag is 0, the prediction method is determined by referring to the prediction method selection information b1.

When the Intra or inter override flag is 0, the inter or intra flag is not referred to. Therefore, the transmission of the inter or intra flag may be omitted. In this case, since only the prediction method selection information b1 is included (i.e., the inter or intra flag is not included) in the bit stream, the structure of the bit stream becomes similar to that of the bit stream according to the first embodiment. Note that the value of the intra or inter override enable flag and the information that is referred to are not limited to those in the above-described example. For example, when the value of the intra or inter override enable flag is 0, the intra or inter flag is referred to, whereas when the value is 1, the prediction method selection information b1 is referred to.

In the video decoding circuit 5 according to the third embodiment, the code decoding unit 51 decodes a bit stream and outputs prediction method selection information b1 that indicates an image prediction method for each component to be decoded to the selection unit 56.

Then, the selection unit 56 performs a selection based on the prediction method selection information b1 so that a prediction image that is predicted by a prediction method indicated by the prediction method selection information b1 is output to the addition unit 57.

As described above, in the video encoding circuit 1 and the video decoding circuit 5 according to the third embodiment, even when only a specific component such as a component corresponding to a wavelength of 300 nm in an image containing a plurality of components considerably differs from other components such as a component corresponding to a wavelength of 500 nm in the image, it is possible to perform an encoding process and a decoding process more efficiently by changing the prediction method only for the specific component.

As described above, in the video encoding circuit 1 according to the third embodiment, the prediction image generation unit 10 further includes a selection unit 14 that selects an intra-frame prediction or an inter-frame prediction. Further, the selection unit 14 preferably determines a prediction method for each component and the encoding unit 40 preferably incorporates prediction method selection information indicating the determined prediction method into the bit stream.

Further, in the video decoding circuit 5 according to the third embodiment, the image restoration unit 52 includes an intra-frame prediction image generation unit 54 and an inter-frame prediction image generation unit 55. Further, the image restoration unit 52 preferably selects a prediction image for each component based on the prediction method selection information and restores an image based on the selected prediction image.

### Fourth Embodiment

In the video encoding circuit 1 and the video decoding circuit 5 according to the first embodiment, a prediction image is generated by referring to a reference image stored in the image memory. In contrast to this, in a video encoding circuit and a video decoding circuit according to a fourth embodiment, a prediction image is generated after converting a reference image by using tone mapping, a tone mapping table of a picture containing components is incorporated into a bit stream. In this way, an encoding process or a decoding process is performed more efficiently.

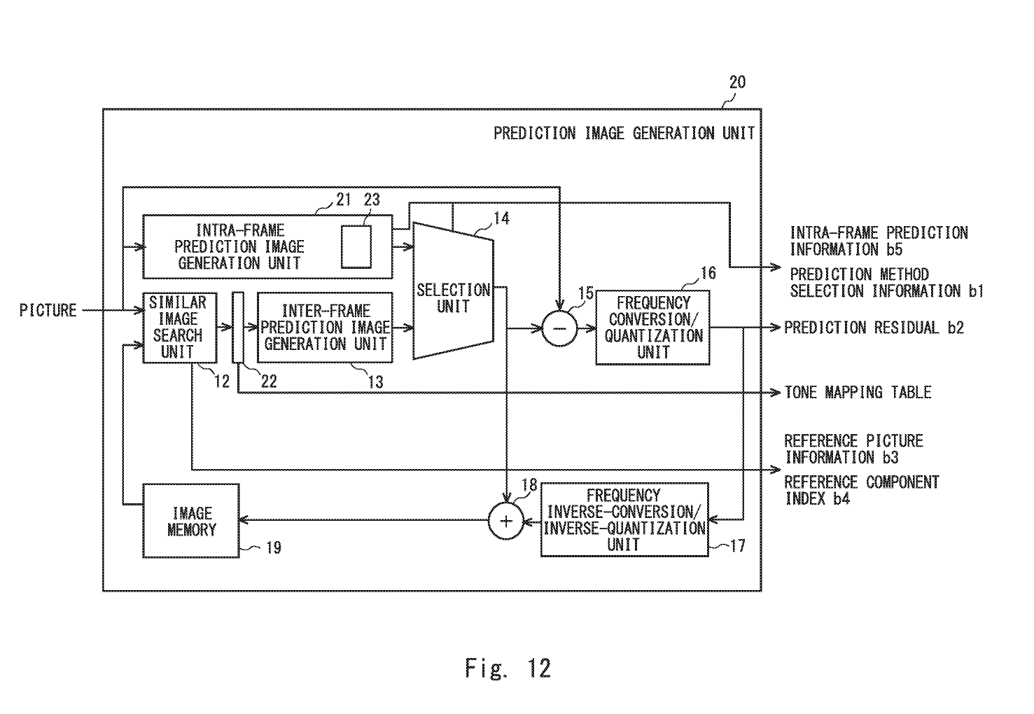

FIG. 12 is a block diagram showing a schematic configuration of a prediction image generation unit 20 according to the fourth embodiment. Compared to the prediction image generation unit 10 according to the first or second embodiment, the prediction image generation unit 20 includes tone mapping processing units 22 and 23.

In the prediction image generation unit 20 according to the fourth embodiment, the tone mapping processing unit 22 performs a tone mapping process on a reference image output from the similar image search unit 12 and outputs the processed reference image to the inter-frame prediction image generation unit 13. Note that the tone mapping in the fourth embodiment means an operation in which each pixel value is converted according to a specific table. The tone mapping process is performed by referring to a tone mapping table recorded in the tone mapping processing unit 22. The tone mapping table may be expressed by a linear function or a nonlinear function. The inter-frame prediction image generation unit 13 generates a prediction image by using the reference image that has undergone the tone mapping process.

Similarly to the tone mapping processing unit 22, the tone mapping processing unit 23 included in the intra-frame prediction image generation unit 21 performs a tone mapping process on each pixel in a picture and thereby generates a prediction image. In this process, similarly to the tone mapping processing unit 22, the tone mapping processing unit 23 outputs a tone mapping table to the encoding unit 40 (not shown). The prediction image selected by the selection unit 14 is added to a processing result of the frequency inverse-conversion/inverse-quantization unit 17 by the addition unit 18 and the addition result is stored in the image memory 19.

The encoding unit 40 incorporates information on the tone mapping table into the bit stream and outputs the bit stream containing the tone mapping table to the decoding circuit. The tone mapping table is preferably included in the parameters of the slice level or a higher level in the schematic structure of the bit stream hierarchy shown in FIG. 6. In this way, it is possible to reduce the number of tone mapping tables contained in the bit stream and thereby reduce the amount of information of the bit stream.

When the tone mapping table is included in the parameters in a level lower than the slice level, there is an advantageous effect that the tone mapping table can be changed, for example, for each macro-block or for each unit for encoding. However, there is a problem that the amount of information on the tone mapping table increases. In such a case, as in the case of the intra or inter override enable flag according to the third embodiment, a flag indicating whether or not a tone mapping table should be referred to may be included in the parameters in the slice level or a higher level. When this flag indicates that the tone mapping table is not referred to, that is, when the flag indicates that the tone mapping process is not performed, the information on the tone mapping table does not need to be contained in the bit stream.

As described above, even when the tone mapping table is included in the parameters in a level lower than the slice level, it is possible to select whether or not the tone mapping process is performed for each macro-block or the like and hence to reduce the amount of information of the bit stream.

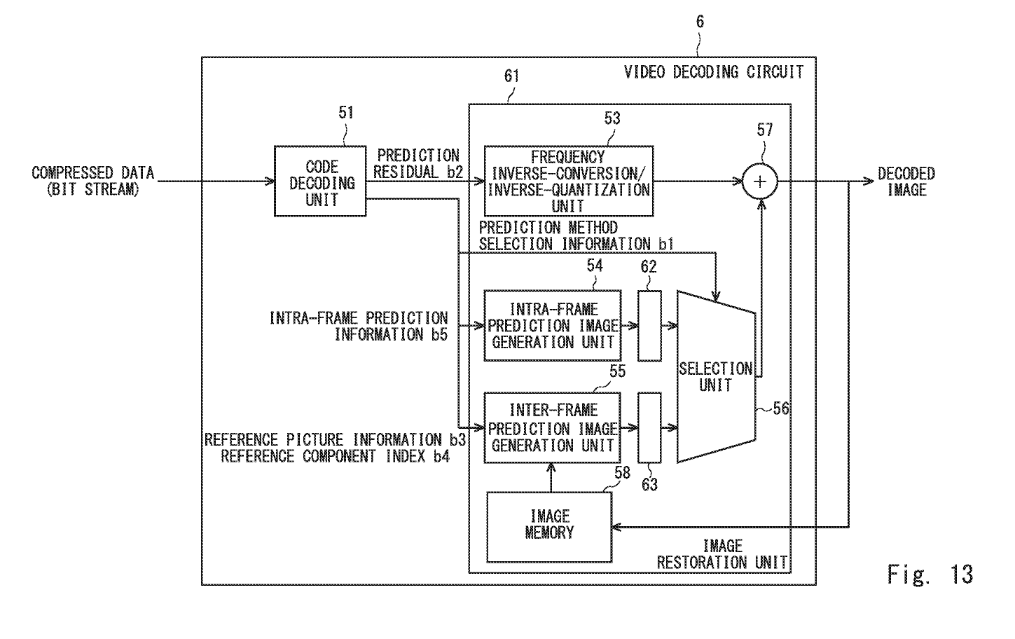

FIG. 13 is a block diagram showing a schematic configuration of a moving picture decoding circuit 6 according to the fourth embodiment.

Compared to the video decoding circuit 5 according to the first or second embodiment, the image restoring unit 61 includes tone mapping processing units 62 and 63. The tone mapping processing units 62 and 63 perform tone-mapping conversion on a prediction image based on a mapping table transmitted from the video encoding circuit. The converted prediction image is added to the prediction residual, which has been frequency inverse-converted/inverse-quantized, in the addition unit 57 and consequently becomes a decoded image.

Note that the tone mapping processing units 62 and 63 may be disposed on the output sides of the intra-frame prediction image generation unit 54 and the inter-frame prediction image generation unit 55, respectively, as shown in FIG. 13. Alternatively, they may be disposed between the selection unit 56 and the addition unit 57. In the prediction image generating unit 20, the tone mapping processing units 22 and 23 need to be disposed on the input side of the selection unit 14 so that the selection unit 14 can select a prediction image based on the image that has already undergone the tone mapping process. However, in the video decoding circuit 6, since a prediction image is selected by using information contained in the bit stream, the tone mapping process does not necessarily have to be performed before the process in the selection unit 56. Therefore, the tone mapping processing units can be disposed on the output side of the selection unit 56 and consequently the number of tone mapping processing units can be reduced to one. As a result, it is possible to reduce the consumption power and the circuit area.

As described above, in the prediction image generation unit and the video decoding circuit 6 according to the fourth embodiment, it is possible to generate a prediction image having a higher degree of similarly by performing a conversion by using tone mapping when average values or tone distributions differ even among components having a high degree of similarity. Consequently, it is possible to perform an encoding process and a decoding process more efficiently.

As described above, in the video encoding circuit 1 according to the fourth embodiment, the prediction image generation unit 20 further includes tone mapping processing units 22 and 23, and the tone mapping processing units 22 and 23 convert pixel values in a reference image by using tone mapping. Further, the prediction image generation unit 20 preferably generates the prediction image based on the converted reference image.

Further, in the video decoding circuit 6 according to the fourth embodiment, the image restoration unit 61 further includes tone mapping processing units 62 and 63, and the tone mapping processing units 62 and 63 preferably restore an image by performing a tone mapping process on a prediction image.

The present disclosure made by the inventors of the present application has been explained above in a concrete manner based on embodiments. However, the present disclosure is not limited to the above-described embodiments, and needless to say, various modifications can be made without departing from the spirit and scope of the present disclosure.

The first to four embodiments can be combined as desirable by one of ordinary skill in the art.

While the present disclosure has been described in terms of several embodiments, those skilled in the art will recognize that the present disclosure can be practiced with various modifications within the spirit and scope of the appended claims and the present disclosure is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A video encoding apparatus comprising:
a prediction image generation unit configured to receive a plurality of pictures, each of the pictures containing a plurality of components, search for a reference image from components of a picture itself or an already-encoded picture stored in a reference memory, and generate a prediction image based on information on a pixel contained in the reference image, the plurality of components corresponding to respective color components contained in the input picture and having wavelengths different from each other, the reference image being used for encoding of each of the plurality of components contained in the input picture; and
an encoding unit configured to generate a bit stream based on the prediction image output from the prediction image generation unit, wherein
the prediction image generation unit outputs a reference component index indicating information on a component containing the reference image, and
the encoding unit outputs a bit stream containing information on the reference component index.

2. The video encoding apparatus according to claim 1, wherein the encoding unit further incorporates information indicating the number of components contained in the picture into the bit stream.

3. The video encoding apparatus according to claim 2, wherein the number of components contained in the picture is four or larger.

4. The video encoding apparatus according to claim 1, wherein the plurality of components include at least one of a component in a wavelength region whose wavelength is longer than that of red and a component in a wavelength region whose wavelength is shorter than that of blue.

5. The video encoding apparatus according to claim 2, wherein the reference component index is expressed by using a component number of a component containing an image to be encoded and the number of components contained in the picture.

6. The video encoding apparatus according to claim 1, further comprising a selection unit configured to select an intra-frame prediction or an inter-frame prediction, wherein
the selection unit determines the prediction method for each component, and
the encoding unit incorporates prediction method selection information indicating the prediction method into the bit stream.

7. The video encoding apparatus according to claim 1, further comprising a tone mapping processing unit, wherein
the tone mapping processing unit converts a pixel value of a reference image by using tone mapping, and
the prediction image generation unit generates the prediction image based on the converted reference image.

8. A video decoding apparatus comprising:
a code decoding unit configured to receive a bit stream and decode the received bit stream, the bit stream containing a plurality of pictures encoded therein, each of the plurality of pictures containing a plurality of components, the plurality of components corresponding to respective color components contained in the picture and having wavelengths different from each other; and
an image restoration unit configured to generate a prediction image based on the decoded information and restore an image by using the prediction image, wherein
the code decoding unit decodes code of a reference component index indicating information on a component containing a prediction image from the bit stream, and
the image restoration unit generates a prediction image by using a pixel value contained in the component indicated by the reference component index and restores an image by using the generated prediction image.

9. The video decoding apparatus according to claim 8, wherein the code decoding unit further decodes information indicating the number of components contained in the picture.

10. The video decoding apparatus according to claim 8, wherein the decoded information includes prediction method selection information indicating a method by which the prediction image is generated and a prediction residual, the prediction residual being a difference between the prediction image and the picture.

11. The video decoding apparatus according to claim 9, wherein the number of components contained in the picture is four or larger.

12. The video decoding apparatus according to claim 8, wherein the plurality of components include at least one of a component in a wavelength region whose wavelength is longer than that of red and a component in a wavelength region whose wavelength is shorter than that of blue.

13. The video decoding apparatus according to claim 9, wherein the reference component index is expressed by using a component number of a component containing an image to be encoded and the number of components contained in the picture.

14. The video decoding apparatus according to claim 10, wherein
the image restoration unit comprises an intra-frame prediction image generation unit and an inter-frame prediction image generation unit, and
the image restoration unit selects a prediction image for each component based on the prediction method selection information and restores an image.

15. The video decoding apparatus according to claim 8, further comprising a tone mapping processing unit, wherein
the tone mapping processing unit performs a tone mapping process on the prediction image and restores an image.
